(19) United States
(12) Patent Application Publication
(10) Pub. No.: US 2009/0250856 A1
(43) Pub. Date: Oct. 8, 2009

(54) WELDING SUPPORT APPARATUS

(76) Inventor: William Tanasiychuk, Bruderheim (CA)

Correspondence Address: DAVIS & BUJOLD, P.L.L.C., 112 PLEASANT STREET, CONCORD, NH, 03301, US

(21) Appl. No.: 12/307,426

(22) PCT Filed: Jul. 5, 2007
(86) PCT No.: PCT/CA2007/001198

§ 371 Date: Jan. 5, 2009

(30) Foreign Application Priority Data
Jul. 5, 2006 (CA) 2,551941

(51) Int. Cl. B23Q 3/154

(52) U.S. Cl. 269/37

(57) ABSTRACT

A welding support assembly includes an elongate workpiece support having a first end, and a second end. The workpiece support is adapted to support a first workpiece in a substantially horizontal position. A back plate is positioned at the first end of the workpiece support, the back plate having a first side and a second side, the plane of the plate being perpendicular to the workpiece support and the first side facing toward the workpiece support, where the relative vertical position of the back plate and the workpiece support is adjustable while maintaining the relative orientation of the back plate and the workpiece support. A magnetizer for magnetizing the back plate such that, when magnetized, the back plate can magnetically hold a second workpiece to the first side of the back plate.

### FIELD

The present application relates to an apparatus for supporting workpieces to be welded together using a magnetic field to support one of the workpieces.

### BACKGROUND

Support apparatuses are commonly used to support workpieces to be welded together, or otherwise joined, such as in U.S. Pat. No. 6,931,715 (Lawrence) and U.S. Pat. No. 5,893,181 (Chu).

### SUMMARY

There is provided a welding support assembly, comprising an elongate workpiece support having a first end, and a second end. The workpiece support is adapted to support a first workpiece in a substantially horizontal position. A back plate is positioned at the first end of the workpiece support, the back plate having a first side and a second side, the plane of the plate being perpendicular to the workpiece support and the first side facing toward the workpiece support, where the relative vertical position of the back plate and the workpiece support is adjustable while maintaining the relative orientation of the back plate and the workpiece support. A magnetizer for magnetizing the back plate is included such that, when magnetized, the back plate can magnetically hold a second workpiece to the first side of the back plate.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side plan view of the workpiece support apparatus.

FIG. 2 is a front elevation view of the workpiece support apparatus.

FIG. 3 is a top plan view of the workpiece support apparatus.

FIG. 4 is a side plan view of a variation of the workpiece support apparatus.

FIG. 5 is a side plan view of the variation of FIG. 4 with the workpiece support in a raised position.

FIG. 6 is a front elevation view of the variation of FIG. 4.

FIG. 7 is a rear elevation view of the variation of FIG. 4.

FIG. 8 is a side plan view of the variation of FIG. 4 with the welding support assembly in an angled position.

### DETAILED DESCRIPTION

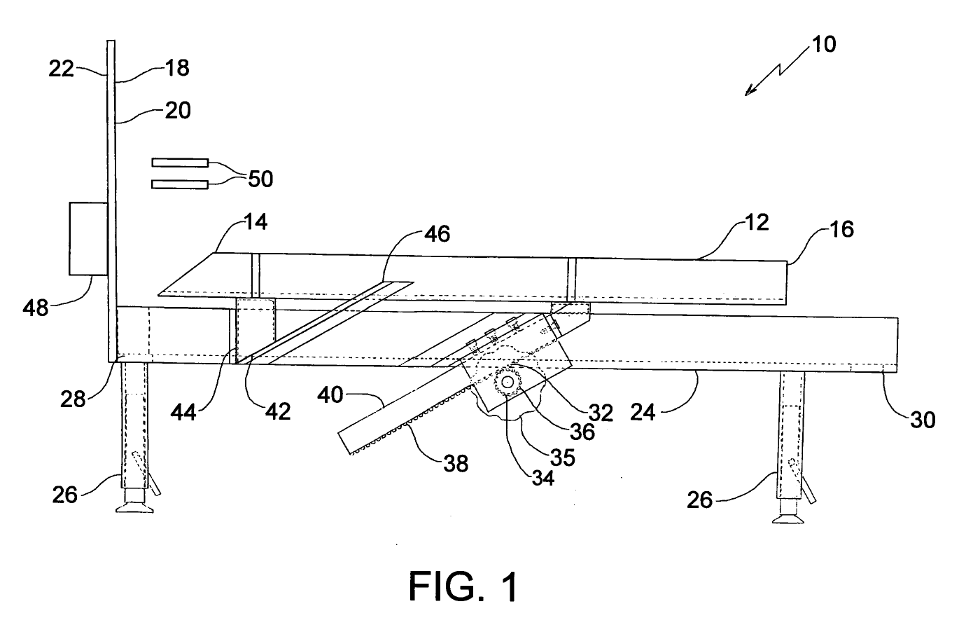

A workpiece support apparatus generally identified by reference numeral 10, will now be described with reference to FIG. 1 through 3.

Structure and Relationship of Parts:

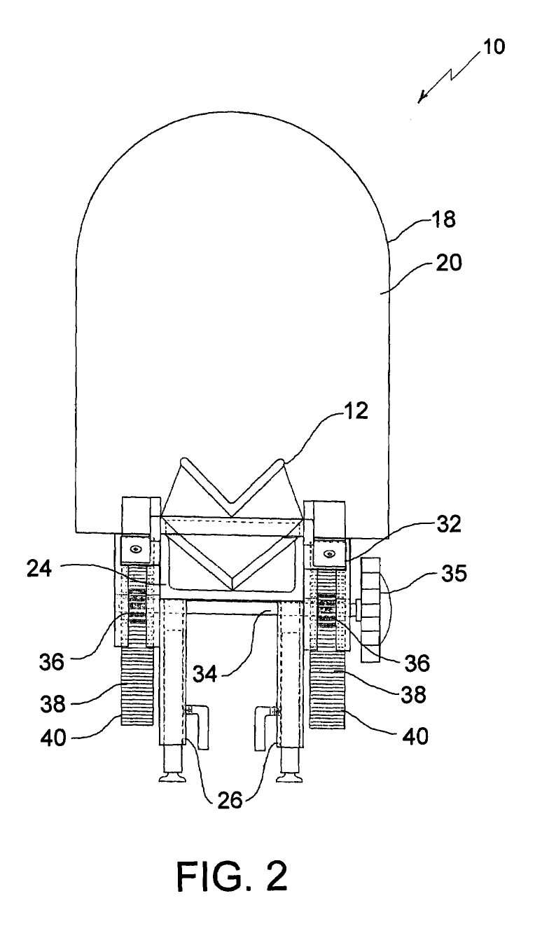

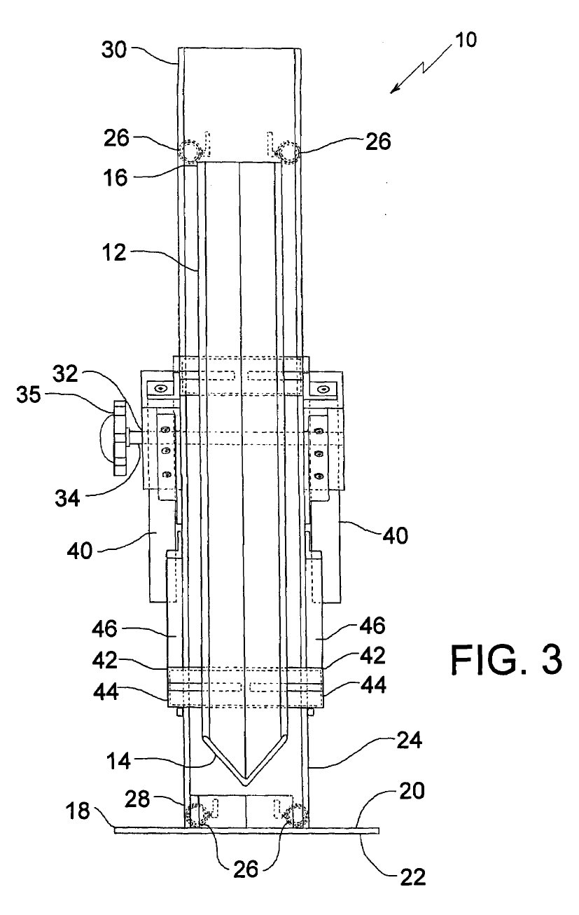

Referring to FIG. 1, welding support assembly 10 includes an elongate workpiece support 12 having a first end 14, a second end 16. Workpiece support 12 is adapted to support a first workpiece (not shown) in a substantially horizontal position. A conductive back plate 18 is positioned at first end 14 of workpiece support 12. Back plate 18 has a first side 20 and a second side 22. The plane of plate 18 is perpendicular to workpiece support 12 with first side 20 facing toward workpiece support 12. Both workpiece support 12 and back plate 18 are supported by a support frame 24 with adjustable legs 26 at each corner of support frame 24. Support frame 24 has a first end 28 and a second end 30, with back plate 18 attached at first end 28 of support frame 24. Workpiece support 12 is attached to support frame 24 by a vertically adjustable connection 32, such that the relative vertical position of back plate 18 and workpiece support 12 is adjustable, while the relative orientation of back plate 18 to workpiece support 12 is maintained. As depicted, vertically adjustable connection 32 comprises a roller 34 having an engagement surface 36 that is attached to support frame 24. Engagement surface 36 of roller 34 engages an engagement surface 38 on a track 40 attached to workpiece support 12, such that rotation of roller 34 adjusts the vertical position of workpiece support 12 relative to back plate 18. Roller 34 is rotated manually using a handle 35. As shown, track 40 has a diagonal orientation, such that workpiece support 12 moves horizontally as well as vertically. Another sliding support 42 is included having two parts 44 and 46, where first part 44 is attached to workpiece support 12, and second part 46 is attached to support frame 24. Sliding support 42 is positioned at the same angle as angle as connection 32, such that sliding support 42 only lends support, and does not affect the travel of workpiece support 12. As can be seen in FIGS. 2 and 3, adjustable connection 32 and sliding support 42 is present on both sides of workpiece support 12.

A magnetizer, such as a magnet 48 is used to allow back plate 18 to hold workpieces to first side 20 of back plate 18. Magnet 48 may be a permanent magnet or an electromagnet and may be removably attached, permanently attached, or embedded in back plate 18. Alternatively, the magnetizer may directly magnetize back plate 18 without using magnet 48 may be used (not illustrated), or may comprise all or a portion of back plate 18 to which workpieces will be attached. As depicted, magnet 48 is connected to second side 22 of back plate 18, such that, when operative, back plate 18 can magnetically hold a second workpiece (not shown) to first side 20 of back plate 18. If the second workpiece comprises a flange, flange pins 50 may also be included to help orient the flange as it is held to back plate 18.

Operation:

Referring to FIG. 1 through 3, welding support assembly 10 is provided as described above. The first step is to place support frame 24 on a flat surface, and ensure it is stable and level by adjusting adjustable legs 26. If a flange is the second workpiece, the flange is placed on assembly 10 with its face against back plate 18. Flange pins 50 are inserted and used to level the flange. Back plate 18 is then magnetized by magnet 48 to hold the flange in place. A pipe to be attached to is placed on workpiece support 12, and the vertical height is adjusted by rotating roller 34, such that engagement surface 38 of track 40 moves along engagement surface 36. Once the inside of the pipe is flush with the inside of the flange, the horizontal position of the pipe is adjusted to allow for a proper welding gap. The connection may then be tack welded to secure the flange to the pipe before the final weld. A person skilled in the art will recognize that different steps may be taken for other pieces that are to be welded together.

Variations:

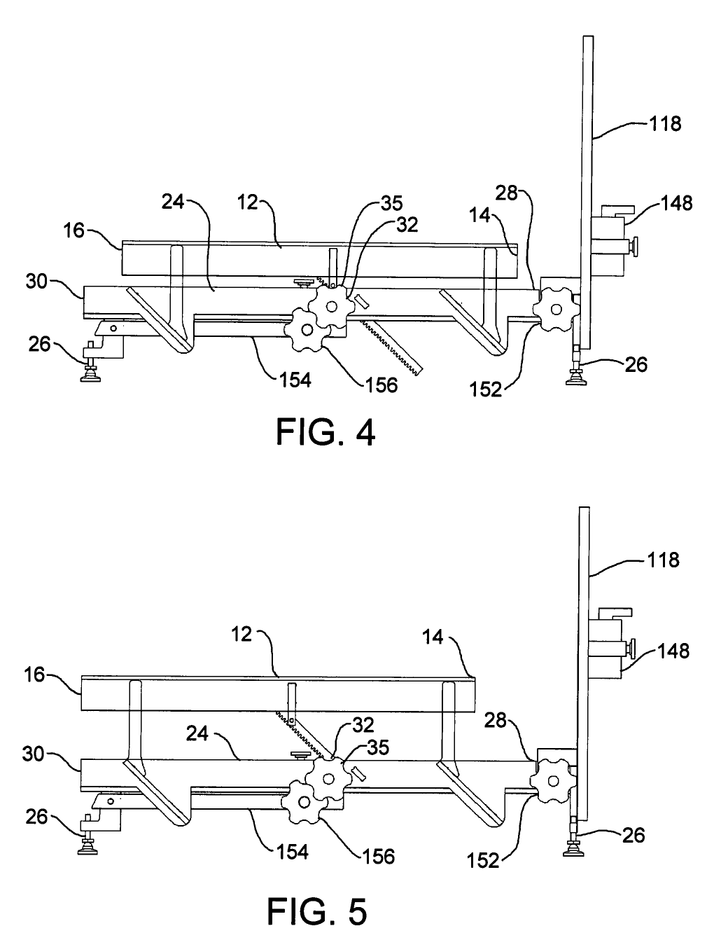

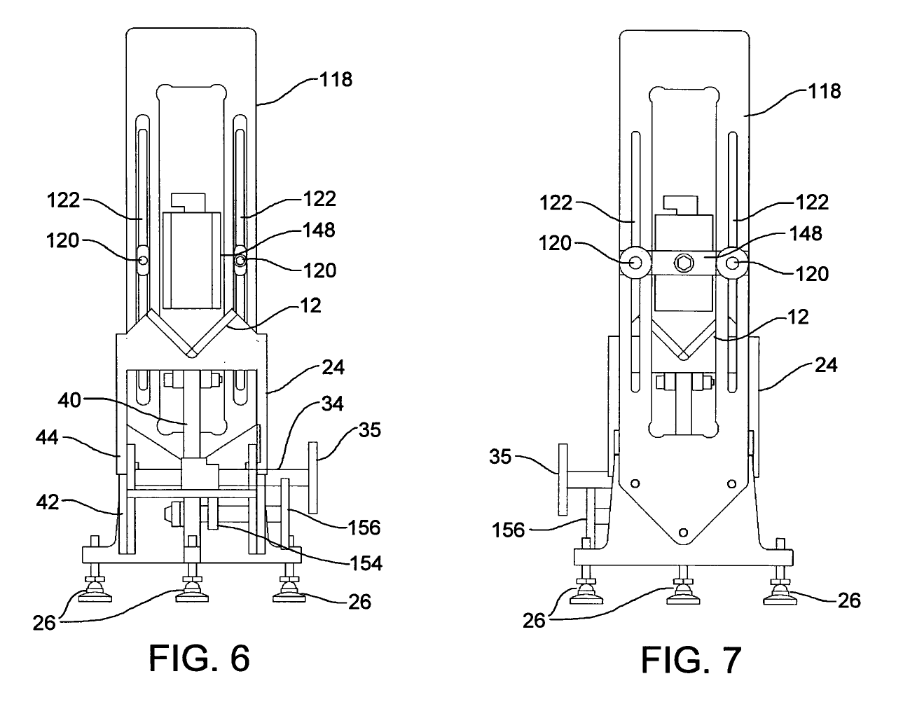

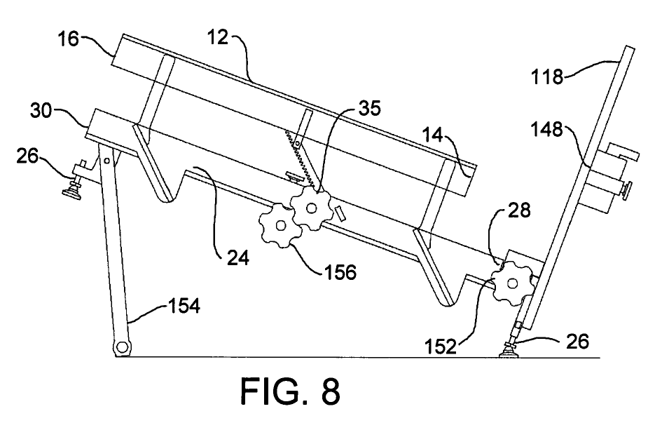

A variation will now be discussed with reference to FIG. 4 through 7 to illustrate some design changes that may be made to the welding support apparatus 10 described above. Referring to FIG. 4, instead of back plate 18, a magnet support 118 may be used that supports a magnet 148, such that a workpiece is held directly against magnet 148. As can be seen in FIG. 6, the height of magnet 148 is adjustable along magnet support 118. As shown this is done by releasing bolts 120, and them along slots 122. Also referring to FIG. 6, some other design choices that may be made include providing a different number of legs 26 (for example three as shown instead of four), and providing a single vertically adjustable connection 32 instead of two that work in tandem as shown in FIG. 2. Referring to FIG. 4, it may be desirable to provide additional adjustment means at first end 14 of workpiece support 12. In the example shown, a handle 152 is provided which, when turned, causes first end 28 of support frame 24 to move side to side. This allows the user to manipulate the position of first end 14 of workpiece support 12 to align workpieces to be welded. Referring to FIG. 8, another design option includes providing a support leg 154. Support leg 154 has a retracted position shown in FIG. 6, where support leg 154 is folded under support frame 24, and an extended position shown in FIG. 8. Support leg 154 is released by a support leg handle 156, although any convenient means may be used to maintain leg 154 in a retracted position until needed. In the extended position, second end 16 of workpiece support 12 is raised above first end 14, such that a workpiece supported by workpiece support 12 is able to be held against another workpiece by gravity.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A welding support assembly, comprising:
an elongate workpiece support having a first end, and a second end, wherein the workpiece support is adapted to support a first workpiece in a substantially horizontal position; and
a magnet support positioned at the first end of the workpiece support, the magnet support supporting a magnet adapted to magnetically hold a second workpiece, where the relative vertical position of the magnet and the workpiece support is adjustable while maintaining the relative orientation of the magnet and the workpiece support.

2. The welding support assembly of claim 1, wherein the magnet support is a back plate positioned at the first end of the workpiece support, the back plate having a plane, a first side and a second side, the plane of the back plate being perpendicular to the workpiece support and the first side facing toward the workpiece support, where the relative vertical position of the back plate and the workpiece support is adjustable while maintaining the relative orientation of the back plate and the workpiece support, the back plate having a magnetizer for magnetizing the back plate such that, when magnetized, the back plate can magnetically hold a second workpiece to the first side of the back plate.

3. The welding support assembly of claim 2, wherein the back plate is conductive, and the magnet is attached to the second side of the back plate, such that the back plate is magnetized to hold the second workpiece.

4. The welding support assembly of claim 1, wherein the magnet is a permanent magnet attached to the magnet support.

5. The welding support assembly of claim 1, wherein the magnet is an electromagnet attached to the magnet support.

6. The welding support assembly of claim 1, wherein the position of the magnet is vertically adjustable along the magnet support.

7. The welding support assembly of claim 1 further comprising a support frame, the support frame having a first end and a second end, where the magnet support is attached to the first end of the support frame, and the workpiece support is attached to the support frame by a vertically adjustable connection.

8. The welding support assembly of claim 7, wherein the support frame is supported by adjustable legs.

9. The welding support assembly of claim 7, wherein the vertically adjustable connection comprises a roller having an engagement surface attached to the support frame, the engagement surface of the roller engaging an engagement surface of a track attached to the workpiece support, such that rotation of the roller adjusts the vertical position of the workpiece support.

10. The welding support assembly of claim 9, wherein the track has a diagonal orientation, such that the workpiece support moves horizontally as well as vertically.

11. The welding support assembly of claim 7, wherein the support frame further comprises a support leg having a retracted position and an extended position, such that, in the extended position, the second end of the workpiece support is raised above the first end of the workpiece, such that the first workpiece is held against the second workpiece by gravity.

12. The welding support assembly of claim 1, wherein the first end of the workpiece support is adapted to move in a plane substantially parallel to the magnet support.

13. The welding support assembly of claim 1, further comprising flange pins for orienting a flange that is held by the magnet.

14. A welding support assembly, comprising:
an elongate workpiece support having a first end, and a second end, wherein the workpiece support is adapted to support a first workpiece in a substantially horizontal position;
a magnet support positioned at the first end of the workpiece support;
a support frame, the support frame having a first end and a second end, where the magnet support is attached to the first end of the support frame, and the workpiece support is attached to the support frame by a vertically adjustable connection, the support frame being supported by adjustable legs; and
a magnet supported by the magnet support, the magnet adapted to magnetically hold a second workpiece to the first side of the magnet support, where the relative vertical position of the magnet support and the workpiece support is adjustable.

15. The welding support assembly of claim 14, wherein the magnet support comprises a conductive back plate having a first side and a second side, the second workpiece being positioned adjacent to the first side, and the magnet being attached to the second side.

16. The welding support assembly of claim 14, wherein the magnet is a permanent magnet.

17. The welding support assembly of claim 14, wherein the magnet is an electromagnet.

19. The welding support assembly of claim 14, wherein the magnet is vertically adjustable along the magnet support.

20. The welding support assembly of claim 14, wherein the vertically adjustable connection comprises a roller having an engagement surface attached to the support frame, the engagement surface of the roller engaging an engagement surface of a track attached to the workpiece support, such that rotation of the roller adjusts the vertical position of the workpiece support.

21. The welding support assembly of claim 20, wherein the track has a diagonal orientation, such that the workpiece support moves horizontally as well as vertically.

22. The welding support assembly of claim 14, further comprising flange pins for orienting a flange that is held to the magnet.

23. The welding support assembly of claim 14, wherein the support frame further comprises a support leg having a retracted position and an extended position, such that, in the extended position, the second end of the support frame is raised above the first end of the support frame, such that the first workpiece is held against the second workpiece by gravity.

24. The welding support assembly of claim 14, wherein the first end of the workpiece support is adapted to move in a plane substantially parallel to the magnet support.
